(19) United States
(12) Patent Application Publication
(10) Pub. No.: US 2019/0065115 A1
(43) Pub. Date: Feb. 28, 2019

(54) MEMORY SYSTEM, OPERATION METHOD OF THE MEMORY SYSTEM, AND MEMORY DEVICE

(71) Applicant: SK hynix Inc., Gyeonggi-do (KR)

(72) Inventors: Jung-Hyun KWON, Seoul (KR); Do-Sun HONG, Gyeonggi-do (KR); Won-Gyu SHIN, Gyeonggi-do (KR)

(21) Appl. No.: 15/980,238

(22) Filed: May 15, 2018

(30) Foreign Application Priority Data
Aug. 30, 2017 (KR) 10-2017-0110071

(51) Int. Cl. G06F 3/06; G06F 13/16

(52) U.S. Cl. CPC G06F 3/0659; G06F 13/1668; G06F 3/0673; G06F 3/0604

(57) ABSTRACT

A memory system includes: a memory controller; and a plurality of memory devices each of which includes a plurality of input pads, where signals of different input pads are set as valid signals, wherein when the memory controller transfers a mask command to the memory devices and one or more valid signals among the valid signals of the memory devices are enabled along with the mask command, commands of a first kind among commands that are transferred to the memory devices from the memory controller after the mask command are implemented in one or more memory devices which correspond to the enabled one or more valid signals.

### CROSS-REFERENCE TO RELATED APPLICATIONS

The present application claims priority of Korean Patent Application No. 10-2017-0110071, filed on Aug. 30, 2017, which is incorporated herein by reference in its entirety.

### BACKGROUND

### 1. Field

Exemplary embodiments of the present invention relate to a memory system.

### 2. Description of the Related Art

In most cases, memory devices and a memory controller for controlling the memory devices are connected in a one-to-many manner.

As shown in FIG. 1A, when a command bus CMD_BUS_0, an address bus ADD_BUS_0, and a data bus DATA_BUS_0 between a memory controller 100 and a memory device 110_0 are separated from a command bus CMD_BUS_1, an address bus ADD_BUS_1, and a data bus DATA_BUS_1 between the memory controller 100 and a memory device 110_1, the memory controller 100 may control the memory device 110_0 and the memory device 110_1 to perform operations that are completely separate from each other. For example, while a read operation is performed in the memory device 110_0, a write operation may be performed in the memory device 110_1.

As shown in FIG. 1B, in a case where the memory devices 110_0 and 110_1 share a command bus CMD_BUS and an address bus ADD_BUS but have separate data buses DATA_BUS_0 and DATA_BUS_1, the memory devices 110_0 and 110_1 may perform a read operation or a write operation concurrently, but they cannot perform an operation individually. For example, a read operation may not be performed only in the memory device 110_0, or a write operation may not be performed only in the memory device 110_1.

### SUMMARY

Embodiments of the present invention are directed to a memory system in which memory devices perform an operation independently.

In accordance with an embodiment of the present invention, a memory system includes: a memory controller; and a plurality of memory devices each of which includes a plurality of input pads, where signals of different input pads are set as valid signals, wherein when the memory controller transfers a mask command to the memory devices and one or more valid signals among the valid signals of the memory devices are enabled along with the mask command, commands of a first kind among commands that are transferred to the memory devices from the memory controller after the mask command are implemented in one or more memory devices which correspond to the enabled one or more valid signals.

In accordance with another embodiment of the present invention, a method for operating a memory system including a memory controller and a plurality of memory devices includes: transferring a mask command from the memory controller to the memory devices and selecting one or more memory devices among the memory devices; applying a first command from the memory controller to the memory devices; implementing the first command in the selected one or more memory devices among the memory devices; applying a second command from the memory controller to the memory devices; and implementing the second command in the memory devices.

In accordance with yet another embodiment of the present invention, a memory device includes: a command receiving circuit suitable for receiving a plurality of command signals; an address receiving circuit suitable for receiving a plurality of address signals; and a data transferring/receiving circuit suitable for transferring/receiving data; a command decoder circuit suitable for generating an internal read signal, an internal write signal, and an internal mask signal by decoding the command signals, and not enabling the internal read signal and the internal write signal when a command mask mode is set; a command mask mode control circuit suitable for performing a setup operation of the command mask mode in response to an internal mask signal; and a memory core suitable for reading data from memory cells corresponding to an address received by the address receiving circuit in response to an enabling of the internal read signal and transferring the data to the data transferring/receiving circuit, and writing data received by the data transferring/receiving circuit into memory cells corresponding to an address received by the address receiving circuit in response to an enabling of the internal write signal.

In accordance with still another embodiment of the present invention, a method for operating a memory system including a memory controller and a plurality of memory devices includes: the memory controller setting a first portion of memory devices among the memory devices in a command mask mode; applying a first command from the memory controller to the memory devices; implementing the first command in memory devices excluding the first portion of the memory devices among the memory devices; applying a second command from the memory controller to the memory devices; and implementing the second command in the memory devices.

In accordance with still another embodiment of the present invention, a memory device includes: a command receiving circuit suitable for receiving a plurality of command signals; an address receiving circuit suitable for receiving a plurality of address signals; and a data transferring/receiving circuit suitable for transferring/receiving data; a command decoder circuit suitable for generating an internal read signal, an internal write signal, and an internal mask signal by decoding the command signals, and not enabling the internal read signal and the internal write signal when a command mask mode is set; a setup circuit suitable for performing a setup operation of the command mask mode in response to the internal setup command and one or more address signals among the address signals; and a memory core suitable for reading data from memory cells corresponding to an address received by the address receiving circuit in response to an enabling of the internal read signal and transferring the data to the data transferring/receiving circuit, and writing data received by the data transferring/receiving circuit into memory cells corresponding to an address received by the address receiving circuit in response to an enabling of the internal write signal.

### BRIEF DESCRIPTION OF THE DRAWINGS

FIGS. 1A and 1B are block diagrams illustrating connection of buses between a memory controller and memory devices.

FIG. 2 is a timing diagram illustrating an operation of a Mode Register Set (MRS) of a memory device in a Per DRAM Addressability (PDA) mode.

FIG. 3 is a block diagram illustrating a memory system in accordance with an embodiment of the present invention.

FIG. 4 is a flowchart describing a process of individually controlling a plurality of memory devices based on a mask command in the memory system 300 shown in FIG. 3.

FIGS. 5A and 5B illustrate an operation of individually controlling memory devices based on a memory controller mask command shown in FIG. 4.

FIG. 6 is a block diagram illustrating a memory device among plurality of memory devices shown in FIG. 3 in accordance with an embodiment of the present invention.

FIG. 7 is a flowchart describing a process of individually controlling a plurality of memory devices based on the setup in the memory system 300 shown in FIG. 3.

FIG. 8 is a block diagram illustrating a memory device among plurality of memory devices shown in FIG. 3 in accordance with another embodiment of the present invention.

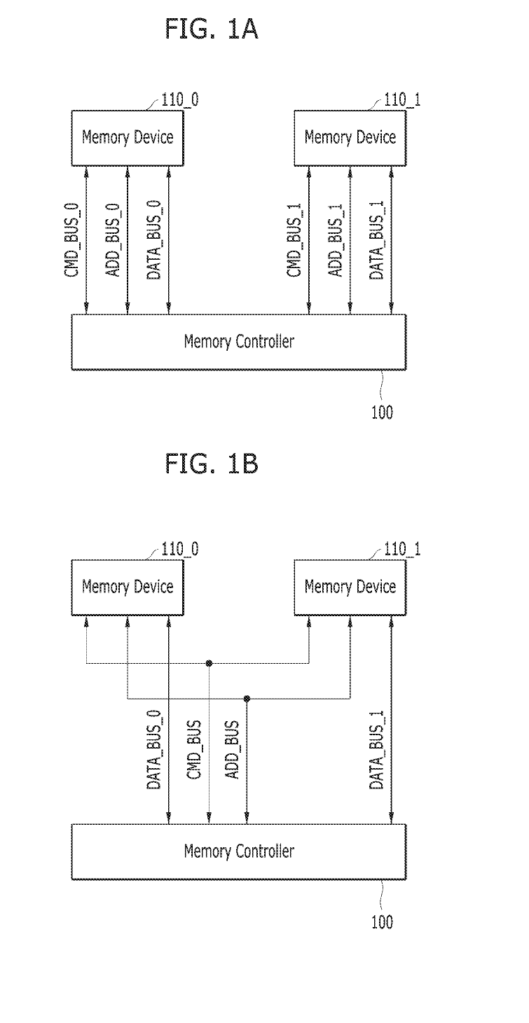

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

It is also noted, that in some instances, as would be apparent to those skilled in the relevant art, an element also referred to as a feature described in connection with one embodiment may be used singly or in combination with other elements of another embodiment, unless specifically indicated otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Before describing the embodiments of the present invention, a Per DRAM Addressability (PDA) mode of a memory device is described, hereafter.

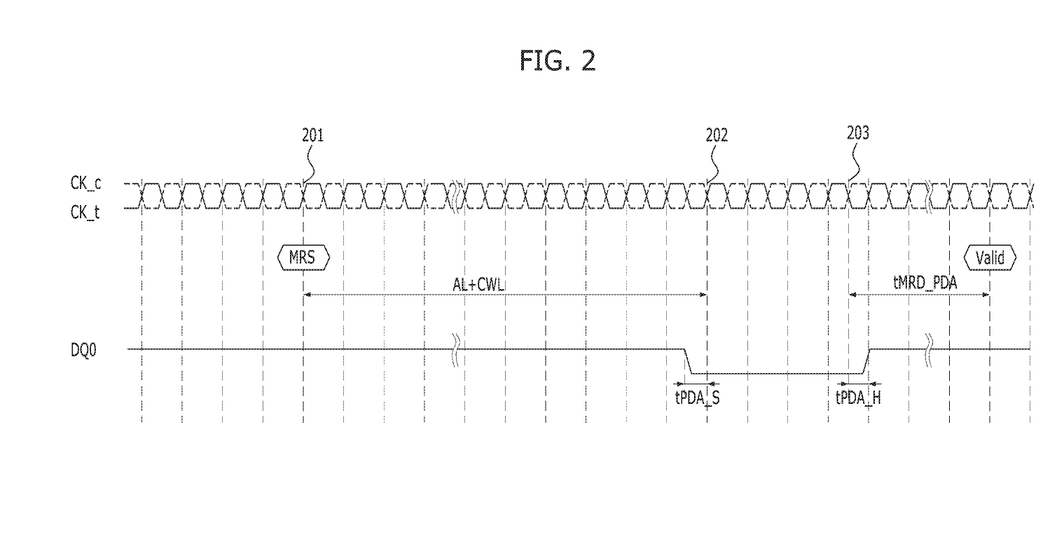

FIG. 2 is a timing diagram illustrating an operation of a Mode Register Set (MRS) of a memory device in a PDA mode.

The PDA mode may be a mode supporting each memory device to independently perform a Mode Register Set (MRS) operation, i.e., a setup operation. When the PDA mode is set, validity of all Mode Register Set (MRS) commands may be decided based on a signal level of a 0^{th} data pad DQO. If the signal level of the 0^{th} data pad DQ0 is ‘0’ at a moment when a write latency WL (which is a sum of an Additive Latency AL and a CAS Write Latency CWL, WL=AL+CWL) passes from a moment when an MRS command is applied, the applied MRS command may be decided to be valid, and if the signal level of the 0^{th} data pad DQ0 is ‘1’, the applied MRS command may be decided to be invalid and thus disregarded.

Referring to FIG. 2, at a moment 201, a MRS command may be applied to a memory device. At a moment 202 when time passes as much as a write latency WL (WL=AL+CWL) from the moment 201, the signal level of the 0^{th} data pad DQ0 may transition to ‘0’ for a predetermined duration. Therefore, the MRS command applied at the moment 201 may be decided to be valid, and thus a setup operation of the memory device may begin based on an address (not shown) inputted along with the MRS command for a duration tMRD_PDA, which is a mode register set command cycle time, from a moment 203.

If the signal level of the 0th data pad DQ0 is maintained to be ‘1’ at the moment 202, the MRS command applied at the moment 201 may be decided to be invalid and disregarded. In other words, the setup operation of the memory device may not be performed.

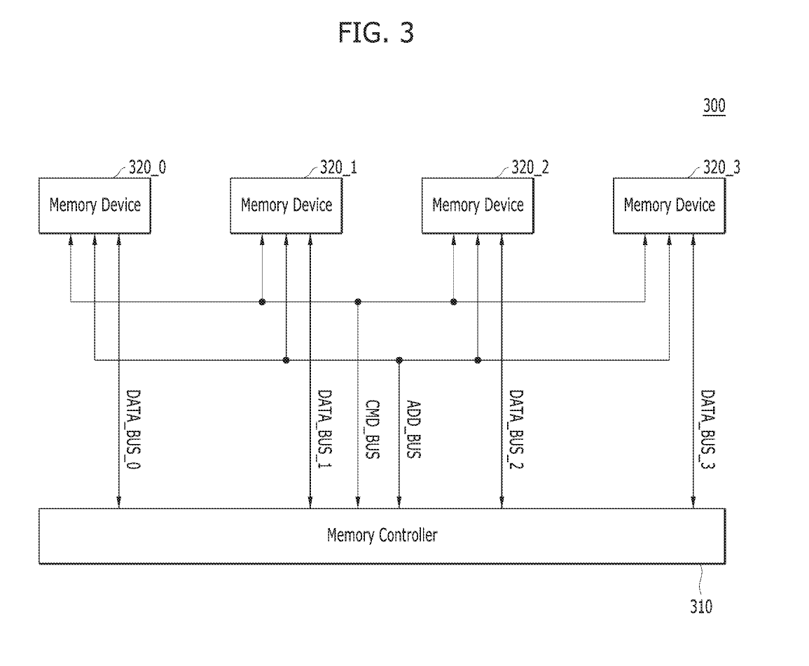

FIG. 3 is a block diagram illustrating a memory system 300 in accordance with an embodiment of the present invention.

Referring to FIG. 3, the memory system 300 may include a memory controller 310 and memory devices 320_0 to 320_3. The memory devices 320_0 to 320_3 may share a command bus CMD_BUS and an address bus ADD_BUS. Also, additional data buses DATA_BUS_0 to DATA_BUS_3 may be provided to the memory devices 320_0 to 320_3, respectively.

The command bus CMD_BUS may be used to transfer command signals from the memory controller 310 to the memory devices 320_0 to 320_3. Since the memory devices 320_0 to 320_3 share the command bus CMD_BUS, the same command signals may be transferred to the memory devices 320_0 to 320_3. The command signals may include an active signal ACT_n, a row address strobe signal RAS_n, a column address strobe signal CAS_n, a write enable signal WE_n, and a chip selection signal CS_n. There may be a buffer circuit or chip for adjusting timing for buffering command signals of the command signals over the command bus CMD_BUS.

The address bus ADD_BUS may be used to transfer address signals from the memory controller 310 to the memory devices 320_0 to 320_3. Since the memory devices 320_0 to 320_3 share the address bus ADD_BUS, the same address signals may be transferred to the memory devices 320_0 to 320_3. The address signals may include a multi-bit bank group address, a multi-bit bank address, and a multi-bit normal address. There may be a buffer circuit or chip for adjusting timing for buffering address signals of the address signals over the address bus ADD_BUS.

The data buses DATA_BUS_0 to DATA_BUS_3 may transfer multi-bit data between the memory controller 310 and the memory devices 320_0 to 320_3. Since the data buses DATA_BUS_0 to DATA_BUS_3 are provided to the memory devices 320_0 to 320_3, respectively, the memory devices 320_0 to 320_3 may transfer/receive different data to/from the memory controller 310.

The memory controller 310 may control the memory devices 320_0 to 320_3 through the command bus CMD_BUS and the address bus ADD_BUS, and transfer/receive data to/from the memory devices 320_0 to 320_3 through the data buses DATA_BUS_0 to DATA_BUS_3. The memory controller 310 may be included in a processor, such as a Central Processing Unit (CPU), a Graphic Processing Unit (GPU), and an Application Processor (AP), or the memory controller 310 may exist over a memory module such as a Dual In-line Memory Module (DIMM). Also, the memory controller 310 may exist in diverse forms. For example, the memory controller 310 may independently exist over a chip in a system (e.g., a computing device, a mobile phone, etc.) including the memory devices 320_0 to 320_3.

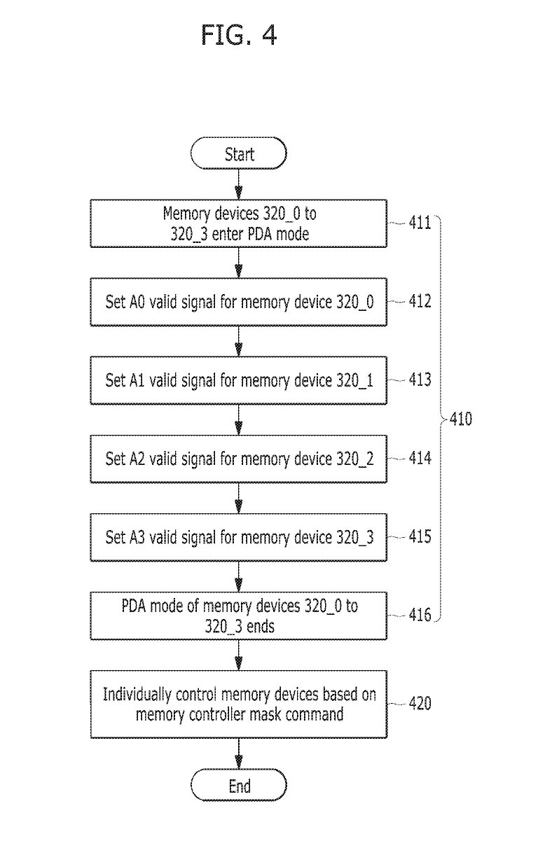

In accordance with an embodiment of the present invention, the memory controller 310 may be able to individually control the memory devices 320_0 to 320_3 based on a mask command, which will be described later in detail with reference to FIGS. 4 to 6.

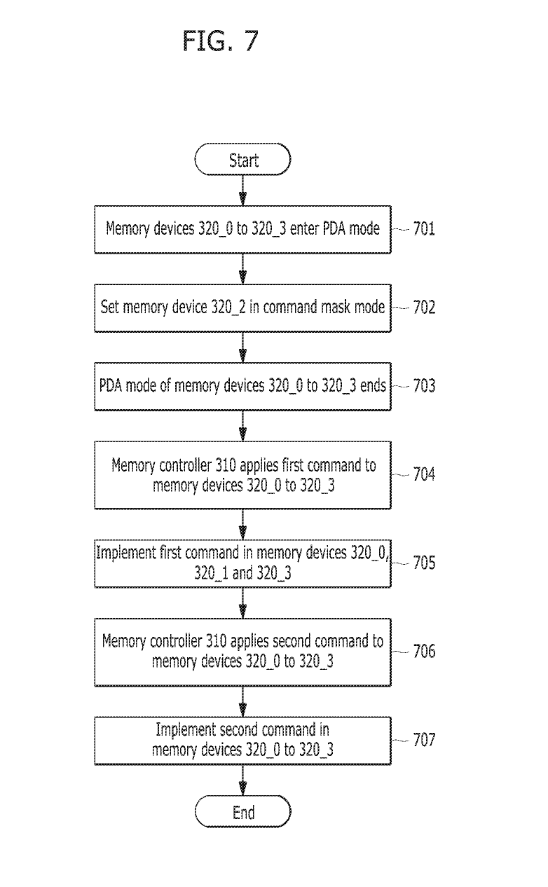

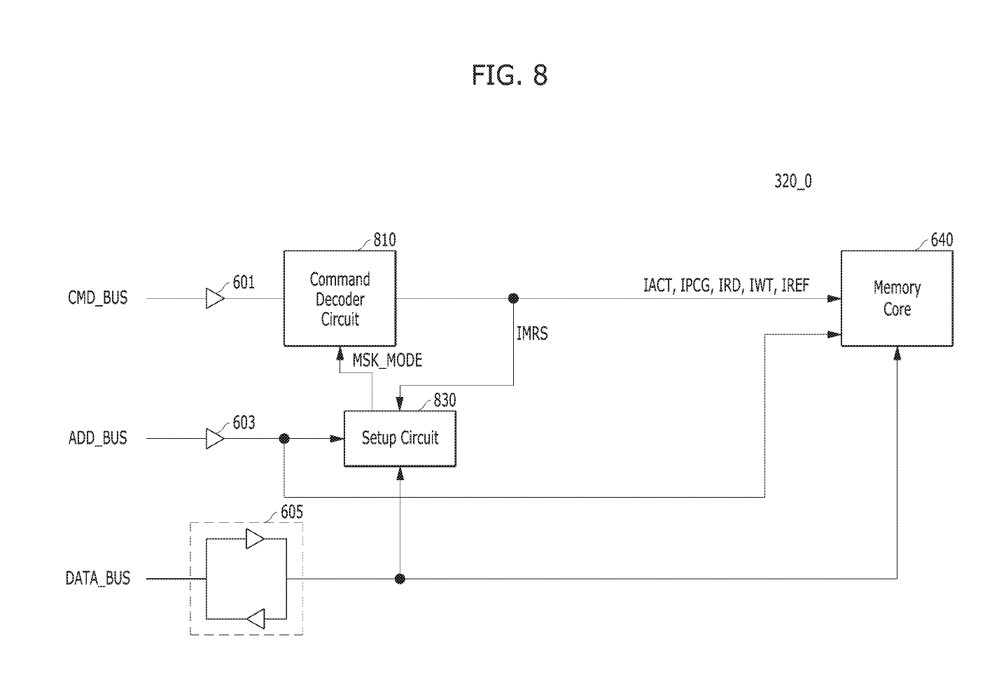

Also, in accordance with an embodiment of the present invention, the memory controller 310 may be able to individually control the memory devices 320_0 to 320_3 based on a setup command, which will be described later in detail with reference to FIGS. 7 and 8.

The memory devices 320_0 to 320_3 may share the command bus CMD_BUS and the address bus ADD_BUS. The memory devices 320_0 to 320_3 may receive the same command signals and the same address signals from the memory controller 310, but they may be able to perform an operation individually by using a mask command. This will be described later in detail with reference to FIGS. 4 to 6.

Also, the memory devices 320_0 to 320_3 may receive the same command signals and the same address signals from the memory controller 310, but they may be able to perform an operation individually by using a setup command. This will be described later in detail with reference to FIGS. 7 and 8.

Each of the memory devices 320_0 to 320_3 may be one among all kinds of memories, such as a Dynamic Random Access

Memory (DRAM), a Phase-Change Random Access Memory (PCRAM), a flash memory, and the like. The memory devices 320_0 to 320_3 may be included in a memory module, such as a DIMM.

Although FIG. 3 illustrates the memory system 300 including four memory devices 320_0 to 320_3, the present disclosure is not limited thereto. That is, it will be obvious to those skilled in the art that the number of the memory devices included in the memory system 300 may be different.

FIG. 4 is a flowchart describing a process of individually controlling the memory devices 320_0 to 320_3 based on a mask command in the memory system 300 shown in FIG. 3.

Referring to FIG. 4, the operation of the memory system 300 may be divided into step 410 of setting up, by the memory controller 310, a valid signal of the memory devices 320_0 to 320_3 and step 420 of individually accessing, by the memory controller 310, the memory devices 320_0 to 320_3. Step 410 may include steps 411 to 416.

In step 411, the memory controller 310 may control the memory devices 320_0 to 320_3 to enter a Per DRAM Addressability (PDA) mode, which may be performed by applying combined command signals transferred through the command bus CMD_BUS to correspond to a Mode Register Set (MRS) and applying combined address signals transferred through the address bus ADD_BUS to correspond to the entering into the PDA mode.

In step 412, after the PDA mode begins, the valid signal of the memory device 320_0 may be set as a 0^{th} normal address A0 by applying combined command signals or an MRS command to correspond to the MRS, applying combined address signals to correspond to the setting of the valid signal of the memory device 320_0 as the 0^{th} normal address A0, and applying a signal of a level ‘0’ onto a transfer line corresponding to the 0^{th} data pad DQ0 of the memory device 320_0 in the data bus DATA_BUS_0 of the memory device 320_0 after a write latency WL passes from a moment when the MRS command is applied. Herein, it is possible to prevent the valid signals of remaining memory devices 320_1 to 320_3 from being set up as the 0^{th} normal address A0 by maintaining the signals of transfer lines corresponding to the 0^{th} data pads DQ0 of the memory devices 320_1 to 320_3 at a level ‘1’ in the data buses DATA_BUS_1 to DATA_BUS_3 of the memory devices 320_1 to 320_3.

In step 413, the valid signal of the memory device 320_1 may be set as a first normal address A1. In step 414, the valid signal of the memory device 320_2 may be set as a second normal address A2. In step 415, the valid signal of the memory device 320_3 may be set as a third normal address A3. The process 413 to 415 of setting up the valid signals of the memory devices 320_1 to 320_3 may be performed in the same manner as setting up the valid signal of the memory device 320_0 in the process described in step 412. Although the embodiment in FIG. 4 describes that the valid signals of the memory devices 320_0 to 320_3 are set as the 0^{th} to third normal addresses A0 to A3, the present disclosure is not limited thereto. That is, the valid signals of the memory devices 320_0 to 320_3 may be set as other signals.

After the valid signals of the memory devices 320_0 to 320_3 are set up, the PDA mode may end in step 416.

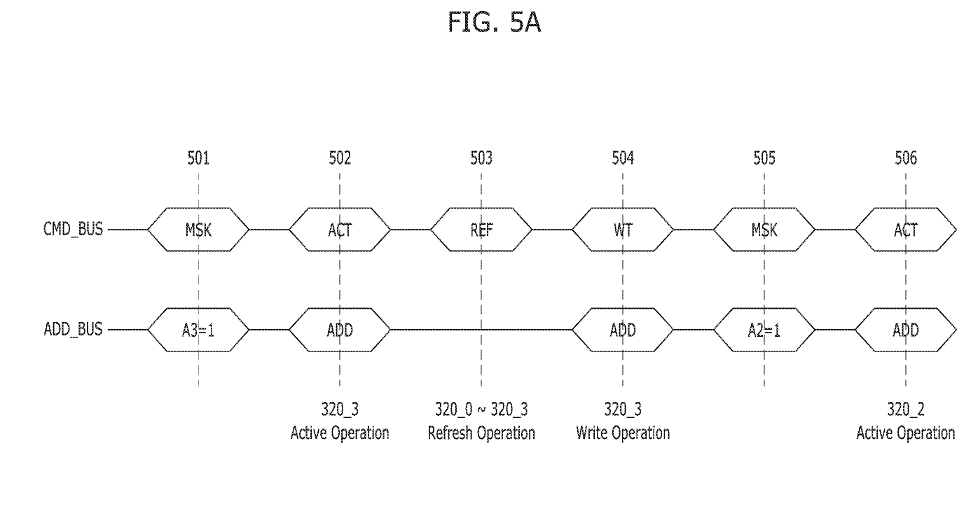

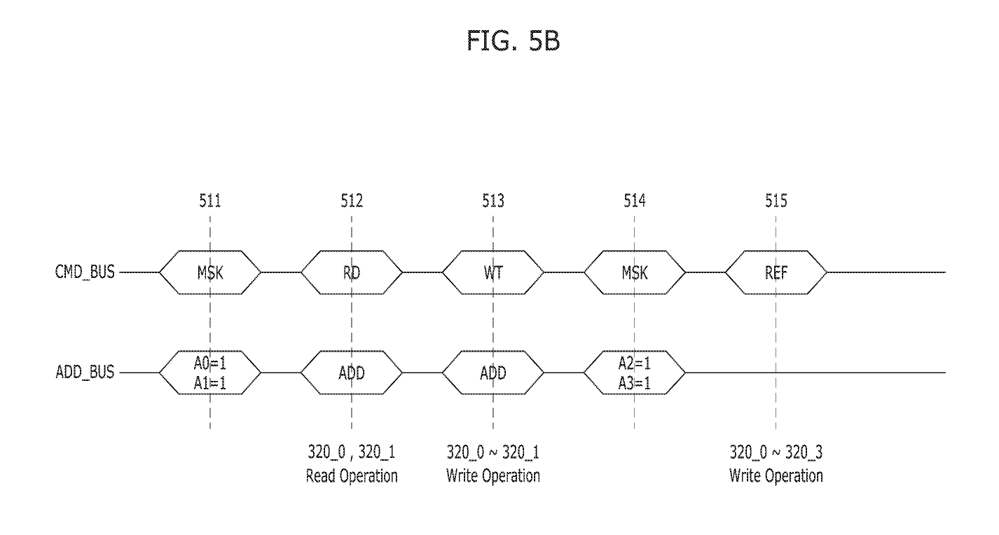

Since the valid signals of the memory devices 320_0 to 320_3 are set up different from each other, the memory controller 310 may individually operate the memory devices 320_0 to 320_3 by using a mask command in step 420. The process 420 of individually operating the memory devices 320_0 to 320_3 by using a mask command will be described in detail with reference to FIGS. 5A and 5B.

The mask command may be used to mask some memory devices from commands. The memory controller 310 may transfer the mask command to the memory devices 320_0 to 320_3 through the command bus CMD_BUS to enable one or more among the valid signals A0, A1, A2 and A3 of the memory devices 320_0 to 320_3.

The memory device corresponding to the valid signal that is enabled when the mask command is applied may be able to recognize the commands transferred after the mask command as valid commands. On the other hand, the memory device corresponding to the valid signal that is disabled when the mask command is applied may recognize the commands transferred after the mask command as invalid commands.

For example, when the mask command is applied from the memory controller 310 to the memory devices 320_0 to 320_3 and the valid signal A2 is enabled, the commands transferred subsequent to the mask command may be implemented in the memory device 320_2, but they may not be implemented in the other memory devices 320_0, 320_1 and 320_3.

A portion of the commands transferred subsequent to the mask command may be a subject of masking, but another portion of the commands transferred subsequent to the mask command may not be the subject of masking.

For example, commands (e.g., an active command, a precharge command, a read command, and a write command) for individually controlling a memory device may be the subject of masking. However, commands (e.g., a command for continuously retaining data of a memory device such as a refresh command, a command for setting up a memory device such as an MRS command, and a command for changing a memory device to be masked such as the mask command) may not be the subject of masking. Herein, it will be obvious to those skilled in the art that the kinds of the listed commands that become the subject of masking are mere examples, and they may be changed depending on how a memory system is designed.

The mask command may be defined with available ones among combinations of command signals. For example, according to the command truth table of the JEDEC DDR4 SPECIFICATION, a combination of a chip selection signal CS_n, an active signal ACT_n, a row address strobe signal RAS_n, a column address strobe signal CAS_n, and a write enable signal WE_n having logic values (L, H, L, H, H) is not defined or available and thus this combination of the commands may be defined as the mask command.

FIGS. 5A and 5B illustrate the process described in step 420 shown in FIG. 4.

Referring to FIG. 5A, a mask command MSK may be applied from the memory controller 310 to the memory devices 320_0 to 320_3 at a moment 501, and the third normal address A3, which is a valid signal of the memory device 320_3, may have an enable level of ‘1’. In this way, the memory devices 320_0 to 320_2 may be masked from commands, except for the memory device 320_3.

At a moment 502, an active command ACT may be applied from the memory controller 310 to the memory devices 320_0 to 320_3, and an address ADD for designating a region where an active operation is to be performed may be applied. As a result, the active operation may be performed in the memory device 320_3, but the active operation may not be performed in the other memory devices 320_0 to 320_2.

At a moment 503, a refresh command REF may be applied from the memory controller 310 to the memory devices 320_0 to 320_3. Since the refresh command REF is a command excluded from the subject of masking, a refresh operation may be performed in all the memory devices 320_0 to 320_3.

At a moment 504, a write command WT may be applied from the memory controller 310 to the memory devices 320_0 to 320_3, and an address ADD for designating a region where a write operation is to be performed may be applied. As a result, the write operation may be performed in the memory device 320_3, but the write operation may not be performed in the other memory devices 320_0 to 320_2.

At a moment 505, a mask command MSK may be applied from the memory controller 310 to the memory devices 320_0 to 320_3, and a second normal address A2 may have an enable level of ‘1’. As a result, the memory devices 320_0, 320_1, and 320_3 may be masked from commands, except for the memory device 320_2. In short, the memory devices masked from commands may be changed based on the mask command MSK that is applied again at the moment 505.

At a moment 506, an active command ACT may be applied from the memory controller 310 to the memory devices 320_0 to 320_3, and an address ADD for designating a region where an active operation is to be performed may be applied. As a result, the active operation may be performed in the memory device 320_2, but the active operation may not be performed in the other memory devices 320_0, 320_1, and 320_3.

Referring to FIG. 5B, at a moment 511, a mask command MSK may be applied from the memory controller 310 to the memory devices 320_0 to 320_3, and an 0th normal address A0 and a first normal address A1, which are valid signals of the memory devices 320_0 and 320_1, may have an enable level of ‘1’. As a result, the memory devices 320_2 and 320_3 may be masked from commands, except for the memory devices 320_0 and 320_1.

At a moment 512, a read command RD may be applied from the memory controller 310 to the memory devices 320_0 to 320_3, and an address ADD for designating a region where a read operation is to be performed may be applied. As a result, the read operation may be performed in the memory devices 320_0 and 320_1, but the read operation may not be performed in the other memory devices 320_2 and 320_3.

At a moment 513, a write command WT may be applied from the memory controller 310 to the memory devices 320_0 to 320_3, and an address ADD for designating a region where a write operation is to be performed may be applied. As a result, the write operation may be performed in the memory devices 320_0 and 320_1, but the write operation may not be performed in the other memory devices 320_2 and 320_3.

At a moment 514, a mask command MSK may be applied from the memory controller 310 to the memory devices 320_0 to 320_3, and a second normal address A2 and a third normal address A3, which are valid signals of the memory devices 320_2 and 320_3, may have an enable level of ‘1’. As a result, the memory devices 320_0 and 320_1 may be masked from commands, except for the memory devices 320_2 and 320_3.

At a moment 515, a refresh command REF may be applied from the memory controller 310 to the memory devices 320_0 to 320_3. Since the refresh command REF is a command excluded from the subject of masking, a refresh operation may be performed in all the memory devices 320_0 to 320_3.

To summarize, FIGS. 5A and 5B illustrate that the memory devices 320_0 to 320_3 sharing the command bus CMD_BUS and the address bus ADD_BUS may perform an operation individually by using the mask command MSK.

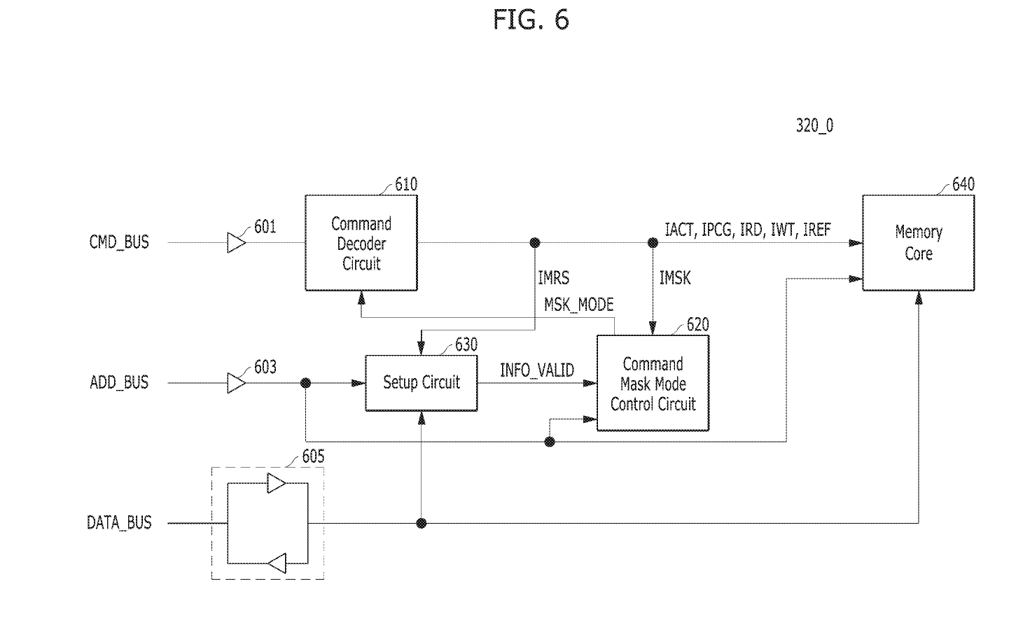

FIG. 6 is a block diagram illustrating the memory device 320_0 shown in FIG. 3 in accordance with an embodiment of the present invention. The memory device of FIG. 3 may operate in the same manner as shown in FIGS. 4, 5A, and 5B. The memory devices 320_0 to 320_3 of FIG. 3 may be designed in the same manner as those shown in FIG. 6.

Referring to FIG. 6, the memory device 320_0 may include a command receiving circuit 601, an address receiving circuit 603, a data transferring/receiving circuit 605, a command decoder circuit 610, a command mask mode control circuit 620, a setup circuit 630, and a memory core 640.

The command receiving circuit 601 may receive command signals from the command bus CMD_BUS. The address receiving circuit 603 may receive address signals from the address bus ADD_BUS. The data transferring/receiving circuit 605 may transfer/receive data to/from the data bus DATA_BUS_0.

The command decoder circuit 610 may generate internal command signals, which may include an internal active signal IACT, an internal precharge signal IPCG, an internal read signal IRD, an internal write signal IWT, an internal refresh signal IREF, an internal mask signal IMSK, and an internal mode register set (MRS) signal IMRS, by decoding the command signals received in the command receiving circuit 601. The internal command signals IACT, IPCG, IRD, IWT, IREF, IMSK, and IMRS may be enabled when the command signals transferred from the command receiving circuit 601 have a combination corresponding to the corresponding command. The command decoder circuit 610 may enable an internal command signal corresponding to a combination of the command signals among the internal command signals IACT, IPCG, IRD, IWT, IREF, IMSK, and IMRS by decoding the command signals in a normal mode, but it may not enable the internal active signal IACT, the internal precharge signal IPCG, the internal read signal IRD, and the internal write signal IWT in a mask mode where a mask mode signal MSK_MODE is enabled. In short, the command decoder circuit 610 may not enable the internal command signals IACT, IPCG, IRD, and IWT corresponding to the masked command in the mask mode. The internal command signals IREF, IMSK, and IMRS corresponding to the commands that are not masked even in the mask mode may be enabled normally.

The setup circuit 630 may decode an address that is received in the address receiving circuit 603 and perform diverse setup operations in response to the enabling of the internal MRS signal IMRS. The setup circuit 630 may receive the entire or part of the address that is received in the address receiving circuit 603. The setup circuit 630 may receive a portion of data that are received in the data transferring/receiving circuit 605 to detect a voltage level of the 0th data pad DQO in the PDA mode. The setup circuit 630 may set up a valid signal of the memory device 320_0, and valid signal information INFO_VALID representing whether the valid signal which is set up may be applied to the command mask mode control circuit 620.

When the internal MRS signal IMRS is enabled and an address signal corresponding to the enabled valid signal among the address signals that are received in the address receiving circuit 603, the command mask mode control circuit 620 may control the command decoder circuit 610 in the normal mode. In other words, the command mask mode control circuit 620 may maintain the mask mode signal MSK_MODE in a disable state.

Also, when the internal MRS signal IMRS is enabled and an address signal corresponding to the disabled valid signal among the address signals that are received in the address receiving circuit 603, the command mask mode control circuit 620 may control the command decoder circuit 610 in the command mask mode. In other words, the command mask mode control circuit 620 may maintain the mask mode signal MSK_MODE in an enable state. As described above, when the mask mode signal MSK_MODE is enabled, the command decoder circuit 610 may not enable the internal command signals IACT, IPCG, IRD and IWT that are masked.

The memory core 640 may perform the major operations of the memory device 320_0, which may include an active operation, a precharge operation, a refresh operation, a read operation, and a write operation. The memory core 640 may include a cell array, a row circuit for controlling an active operation, a precharge operation, and a refresh operation of the cell array, and a column circuit for controlling a read operation and a write operation of the cell array. The memory core 640 may perform an operation corresponding to an enabled internal command signal among the internal command signals IACT, IPCG, IRD, IWT, and TREF. The memory core 640 may receive an address that is received in the address receiving circuit 603 for an operation requiring an address, such as an active operation, a read operation, and a write operation. Also, a data that is read from the memory core 640 may be transferred to the data bus DATA_BUS_0 through the data transferring/receiving circuit 605 during a read operation, and a data that is to be programmed in the memory core 640 may be transferred from the data transferring/receiving circuit 605 during a write operation.

FIG. 7 is a flowchart describing a process of individually controlling the memory devices 320_0 to 320_3 based on the setup in the memory system 300 shown in FIG. 3.

Referring to FIG. 7, in step 701, the memory controller 310 may control the memory devices 320_0 to 320_3 to enter a PDA mode. This may be carried out by applying command signals transferred to the command bus CMD_BUS to a combination corresponding to an MRS command and applying address signals transferred to the address bus ADD_BUS to a combination corresponding to the entering into the PDA mode.

After a PDA mode begins, a portion of the memory devices 320_0 to 320_3 (for example, the memory device 320_2, herein) may be set in a command mask mode in step 702. This may be carried out by applying the command signals to a combination corresponding to the MRS command, applying the address signals to a combination corresponding to the setting of the memory device in the command mask mode, and applying signals of a transfer line corresponding to the 0^{th} data pad DQ0 of the memory device 320_2 at a disable level of ‘0’ after a write latency WL passes from a moment when the MRS command is applied. Herein, the signals of the transfer line corresponding to the 0^{th} data pad DQ0 of the memory devices 320_0, 320_1, and 320_3 may be maintained at the enable level of to prevent the memory devices 320_0, 320_1, and 320_3 from being set in the command mask mode. In the memory device 320_2 that is set in the command mask mode, an active command, a precharge command, a read command, and a write command may not be implemented, and a command such as a refresh command and the MRS command, may be implemented.

After the memory device 320_2 is set in the command mask mode, the PDA mode of the memory devices 320_0 to 320_3 may end in step 703.

When a first command is applied from the memory controller 310 to the memory devices 320_0 to 320_3 in step 704, where the first command represents one among the commands that are masked in the command mask mode, the first command may be implemented only in the memory devices 320_0, 320_1, and 320_3 and the first command may not be implemented only in the memory device 320_2 in step 705.

When a second command is applied from the memory controller 310 to the memory devices 320_0 to 320_3 in step 706, where the second command represents one among the commands that are not masked in the command mask mode, the second command may be implemented in all the memory devices 320_0 to 320_3 in step 707.

A process of canceling the command mask mode of the memory device 320_2 or changing the memory device that is controlled in the command mask mode from the memory device 320_2 into another memory device may be performed in the method of the step 701 to 703.

FIG. 8 is a block diagram illustrating the memory device 320_0 shown in FIG. 3 in accordance with another embodiment of the present invention. The memory device of FIG. 8 may operate as described in FIG. 7. The memory devices 320_1 to 320_3 of FIG. 3 may be designed in the same manner as those of FIG. 8.

Referring to FIG. 8, the memory device 320_0 may include the command receiving circuit 601, the address receiving circuit 603, the data transferring/receiving circuit 605, a command decoder circuit 810, a setup circuit 830, and the memory core 640.

The command receiving circuit 601 may receive command signals from the command bus CMD_BUS. The address receiving circuit 603 may receive address signals from the address bus ADD_BUS. The data transferring/receiving circuit 605 may transfer/receive data to/from the data bus DATA_BUS_0.

The command decoder circuit 810 may generate internal command signals, which may include an internal active signal IACT, an internal precharge signal IPCG, an internal read signal IRD, an internal write signal IWT, an internal refresh signal IREF, and an internal mode register set (MRS) signal IMRS, by decoding the command signals received in the command receiving circuit 601. The internal command signals IACT, IPCG, IRD, IWT, IREF and IMRS may be enabled when the command signals transferred from the command receiving circuit 601 have a combination corresponding to the corresponding command. The command decoder circuit 810 may enable an internal command signal corresponding to a combination of the command signals among the internal command signals IACT, IPCG, IRD, IWT, IREF, and IMRS by decoding the command signals in a normal mode, but it may not enable the internal active signal IACT, the internal precharge signal IPCG, the internal read signal IRD, and the internal write signal IWT in a mask mode where a mask mode signal MSK_MODE is enabled. In short, the command decoder circuit 810 may not enable the internal command signals IACT, IPCG, IRD and IWT corresponding to the masked command in the mask mode. The internal command signals IREF and IMRS corresponding to the commands that are not masked even in the mask mode may be enabled normally.

The setup circuit 830 may decode an address that is received in the address receiving circuit 603 and perform diverse setup operations in response to the enabling of the internal MRS signal IMRS. The setup circuit 830 may receive the entire or part of the address that is received in the address receiving circuit 603. The setup circuit 830 may receive a portion of data that are received in the data transferring/receiving circuit 605 to detect a voltage level of the 0^{th} data pad DQO in the PDA mode. The setup circuit 830 may set up the memory device 320_0 in the command mask mode, and the setup circuit 830 may enable a mask mode signal MSK_MODE when the command mask mode is set up.

The memory core 640 may perform the major operations of the memory device 320_0, which include an active operation, a precharge operation, a refresh operation, a read operation, and a write operation. The memory core 640 may include a cell array, a row circuit for controlling an active operation, a precharge operation, and a refresh operation of the cell array, and a column circuit for controlling a read operation and a write operation of the cell array. The memory core 640 may perform an operation corresponding to an enabled internal command signal among the internal command signals IACT, IPCG, IRD, IWT, and IREF. The memory core 640 may receive an address that is received in the address receiving circuit 603 for an operation requiring an address, such as an active operation, a read operation, and a write operation. Also, a data that is read from the memory core 640 may be transferred to the data bus DATA_BUS_0 through the data transferring/receiving circuit 605 during a read operation, and a data that is to be programmed in the memory core 640 may be transferred from the data transferring/receiving circuit 605 during a write operation.

According to the embodiments of the present invention, memory devices in the inside of a memory system may be operated independently.

While the present invention has been described with respect to the specific embodiments, it will be apparent to those skilled in the art that various changes and modifications may be made without departing from the spirit and scope of the invention as defined in the following claims.

What is claimed is:

1. A memory system, comprising:
a memory controller; and
a plurality of memory devices, each including a plurality of input pads, where signals of different input pads are set as valid signals,
wherein when the memory controller transfers a mask command to the memory devices and one or more valid signals among the valid signals of the memory devices are enabled along with the mask command, commands of a first kind among commands that are transferred to the memory devices from the memory controller after the mask command are implemented in one or more memory devices which correspond to the enabled one or more valid signals.

2. The memory system of claim 1, wherein commands of a second kind among the commands that are transferred to the memory devices from the memory controller after the mask command are implemented in all the memory devices.

3. The memory system of claim 2, wherein the commands of the first kind include an active command, a precharge command, a read command, and a write command.

4. The memory system of claim 3, wherein the commands of the second kind include a mask command and a refresh command.

5. The memory system of claim 1, further comprising:
a common command bus suitable for transferring a command from the memory controller to the memory devices; and
a common address bus suitable for transferring an address from the memory controller to the memory devices.

6. The memory system of claim 5, wherein the input pads are pads for receiving address signals from the common address bus, and
each of the memory devices sets a different address signal as a valid signal.

7. The memory system of claim 1, wherein the valid signals are set in the memory devices based on a Per DRAM Addressability (PDA) mode.

8. A method for operating a memory system including a memory controller and a plurality of memory devices, comprising:
transferring a mask command from the memory controller to the memory devices and selecting one or more memory devices among the memory devices;
applying a first command from the memory controllerto the memory devices;
implementing the first command in the selected one or more memory devices among the memory devices;
applying a second command from the memory controller to the memory devices; and
implementing the second command in the memory devices.

9. The method of claim 8, wherein the first command is one among an active command, a precharge command, a read command, and a write command.

10. The method of claim 9, wherein the second command is one among a mask command and a refresh command.

11. The method of claim 8, wherein each of the memory devices includes a plurality of input pads, where signals of different input pads are set as valid signals, and
one or more valid signals corresponding to the selected one or more memory devices which is selected along with the transfer of the mask command in the transferring of the mask command from the memory controller to the memory devices and the selecting of one or more memory devices among the memory devices are enabled.

12. The method of claim 11, wherein the input pads are pads for receiving address signals, and
each of the memory devices sets a different address signal as a valid signal.

13. The method of claim 12, further comprising:
the memory devices entering a Per DRAM Addressability (PDA) mode under a control of the memory controller;
setting a different value of an address signal as a valid signal in each of the memory devices under a control of the memory controller; and
the memory devices exiting from the PDA mode under a control of the memory controller, before the mask command is transferred.

14. A memory device, comprising:
a command receiving circuit suitable for receiving a plurality of command signals;
an address receiving circuit suitable for receiving a plurality of address signals; and
a data transferring/receiving circuit suitable for transferring/receiving data;
a command decoder circuit suitable for generating an internal read signal, an internal write signal, and an internal mask signal by decoding the command signals, and not enabling the internal read signal and the internal write signal when a command mask mode is set;
a command mask mode control circuit suitable for performing a setup operation of the command mask mode in response to an internal mask signal; and
a memory core suitable for reading data from memory cells corresponding to an address received by the address receiving circuit in response to an enabling of the internal read signal and transferring the data to the data transferring/receiving circuit, and writing data received by the data transferring/receiving circuit into memory cells corresponding to an address received by the address receiving circuit in response to an enabling of the internal write signal.

15. The memory device of claim 14, wherein the command mask mode control circuit controls the command decoder circuit in a normal mode when the internal mask signal is enabled and a valid signal corresponding to the memory device is enabled, and
the command mask mode control circuit controls the command decoder circuit in the command mask mode when the internal mask signal is enabled and the valid signal corresponding to the memory device is disabled.

16. The memory device of claim 15, wherein the command decoder circuit further generates an internal active signal, an internal precharge signal, and an internal refresh signal by decoding the command signals, and
does not enable the internal active signal and the internal precharge signal when the command mask mode is set up.

17. The memory device of claim 14, further comprising:
a setup circuit suitable for setting one signal among the address signals as the valid signal.

18. The memory device of claim 17, wherein the memory device is included in a memory module, and shares the command signals and the address signals with other memory devices that are included in the memory module, and
the memory device and the other memory devices have different address signals to be set as valid signals.

19. A method for operating a memory system including a memory controller and a plurality of memory devices, comprising:
the memory controller setting a first portion of memory devices among the memory devices in a command mask mode;
applying a first command from the memory controller to the memory devices;
implementing the first command in memory devices excluding the first portion of the memory devices among the memory devices;
applying a second command from the memory controller to the memory devices; and
implementing the second command in the memory devices.

20. The method of claim 19, wherein the first command is one among an active command, a precharge command, a read command, and a write command.

21. The method of claim 20, wherein the second command is one among a refresh command and a setup command.

22. The method of claim 19, wherein the setting of the first portion of the memory devices among the memory devices in a command mask mode includes:
the memory devices entering a Per DRAM Addressability (PDA) mode under a control of the memory controller;
the memory controller transferring a valid command mask mode setup command only to the first portion of the memory devices among the memory devices; and
the memory devices exiting from the PDA mode under a control of the memory controller,

23. A memory device, comprising:
a command receiving circuit suitable for receiving a plurality of command signals;
an address receiving circuit suitable for receiving a plurality of address signals; and
a data transferring/receiving circuit suitable for transferring/receiving data;
a command decoder circuit suitable for generating an internal read signal, an internal write signal, and an internal mask signal by decoding the command signals, and not enabling the internal read signal and the internal write signal when a command mask mode is set;
a setup circuit suitable for performing a setup operation of the command mask mode in response to the internal setup command and one or more address signals among the address signals; and
a memory core suitable for reading data from memory cells corresponding to an address received by the address receiving circuit in response to an enabling of the internal read signal and transferring the data to the data transferring/receiving circuit, and writing data received by the data transferring/receiving circuit into memory cells corresponding to an address received by the address receiving circuit in response to an enabling of the internal write signal.

24. The memory device of claim 23, wherein the command decoder circuit further generates an internal active signal, an internal precharge signal, and an internal refresh signal by decoding the command signals, and
does not enable the internal active signal and the internal precharge signal when the command mask mode is set up.

25. A memory system comprising:
a plurality of memory devices suitable for performing operations in response to individual and common commands; and
a controller coupled to the memory device commonly through a command bus commonly transferring the commands and individually through individual data buses individually transferring data for the respective memory devices, and suitable for controlling the memory devices commonly through the common commands and individually through the individual commands,
wherein the common commands include a mask command,
wherein the individual commands include a valid signal, and
wherein the respective memory devices ignore, upon reception of the mask command without corresponding valid signal, subsequent individual commands.
